(19) United States
(12) Patent Application Publication
(10) Pub. No.: US 2014/0063733 A1
(43) Pub. Date: Mar. 6, 2014

(54) ELECTRONIC DEVICE WITH FAN

(71) Applicants: BEN-FAN XIA, KunShan City (CN); ZHEN-YU WANG, KunShan City (CN)

(72) Inventors: BEN-FAN XIA, KunShan City (CN); ZHEN-YU WANG, KunShan City (CN)

(21) Appl. No.: 13/659,919

(22) Filed: Oct. 25, 2012

(30) Foreign Application Priority Data
Aug. 31, 2012 (CN) 2012103176035

(51) Int. Cl. G06F 1/20

(52) U.S. Cl. 361/679.48

(57) ABSTRACT

An electronic device includes a mainboard and a fan mounted on the mainboard. The fan includes a stator and a rotor. The rotor includes a hub covering around a periphery of the stator, and a plurality of blades disposed at a periphery of the hub. The stator is directly fixed to and directly electrically connected to the mainboard.

### BACKGROUND

1. Technical Field

The disclosure relates to electronic devices, and particularly to an electronic device with a fan.

2. Description of Related Art

Nowadays, with the development of electronic technology, an electronic device such as a computer or a server is devised to be much thinner and smaller than before, yet hold many more electronic modules. However, the electronic modules generate a large amount of heat during operation. The interior space of the electronic device is very limited, and the electronic modules occupy much of that space. Therefore, the space saved for a fan for dissipating heat generated from the electronic modules is becoming smaller and smaller.

What is needed, therefore, is an electronic device with a fan which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of an electronic device in accordance with an embodiment of the disclosure.

FIG. 2 is an exploded view of the electronic device of FIG. 1.

FIG. 3 is an inverted view of the electronic device of FIG. 2.

FIG. 4 is a cross-sectional view of the electronic device of FIG. 1, taken along line IV-IV thereof.

### DETAILED DESCRIPTION

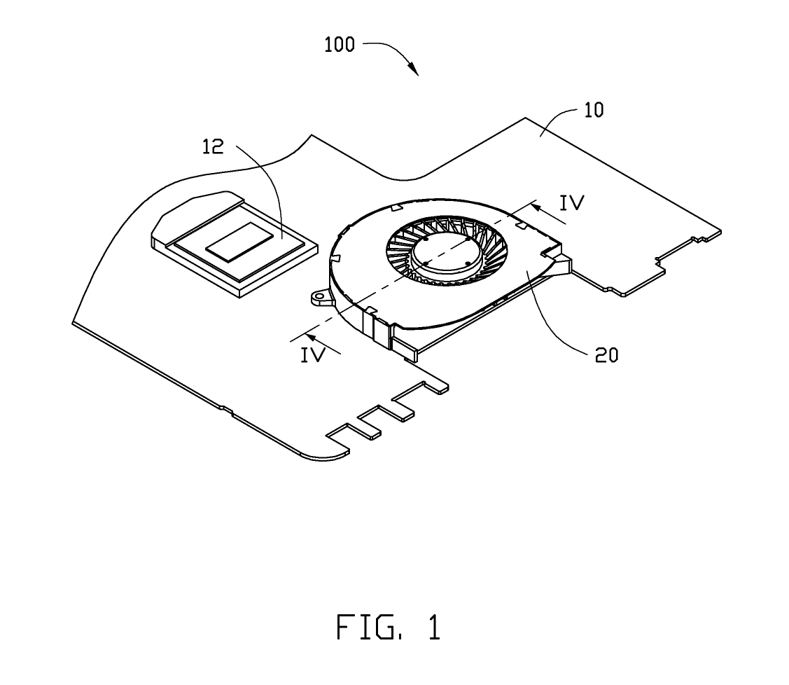

Referring to FIG. 1, an electronic device 100 in accordance with an embodiment of the disclosure includes a mainboard 10 and a centrifugal fan 20 mounted on the mainboard 10. The fan 20 is used for dissipating heat generated from an electronic component 12 mounted on the mainboard 10.

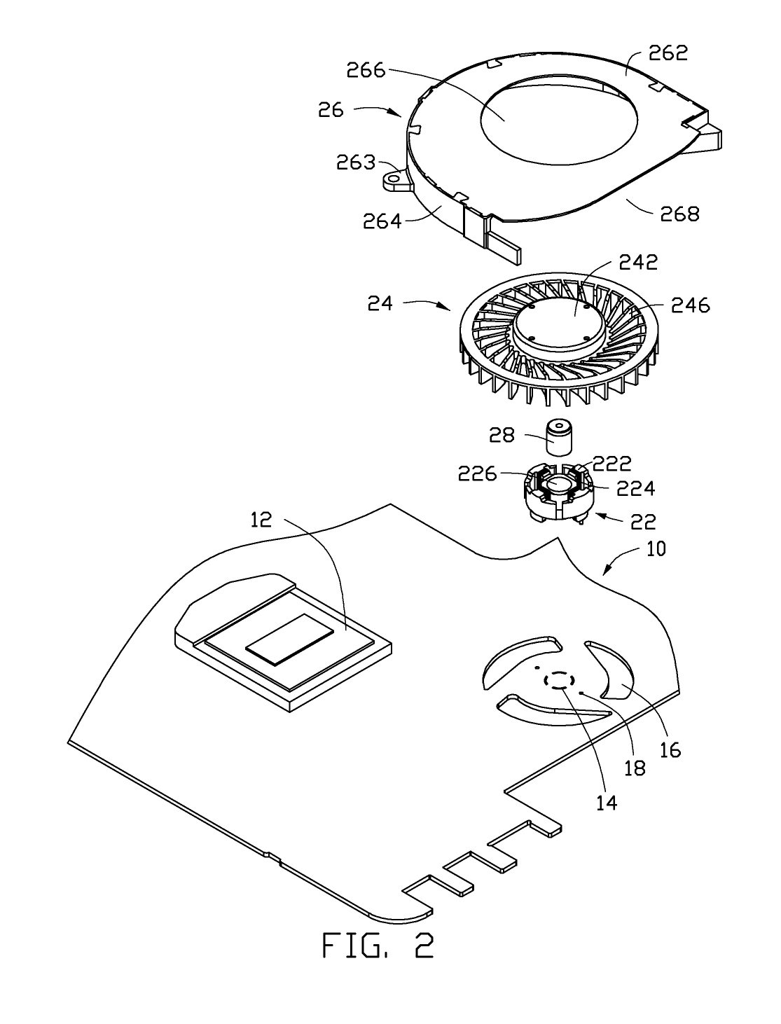

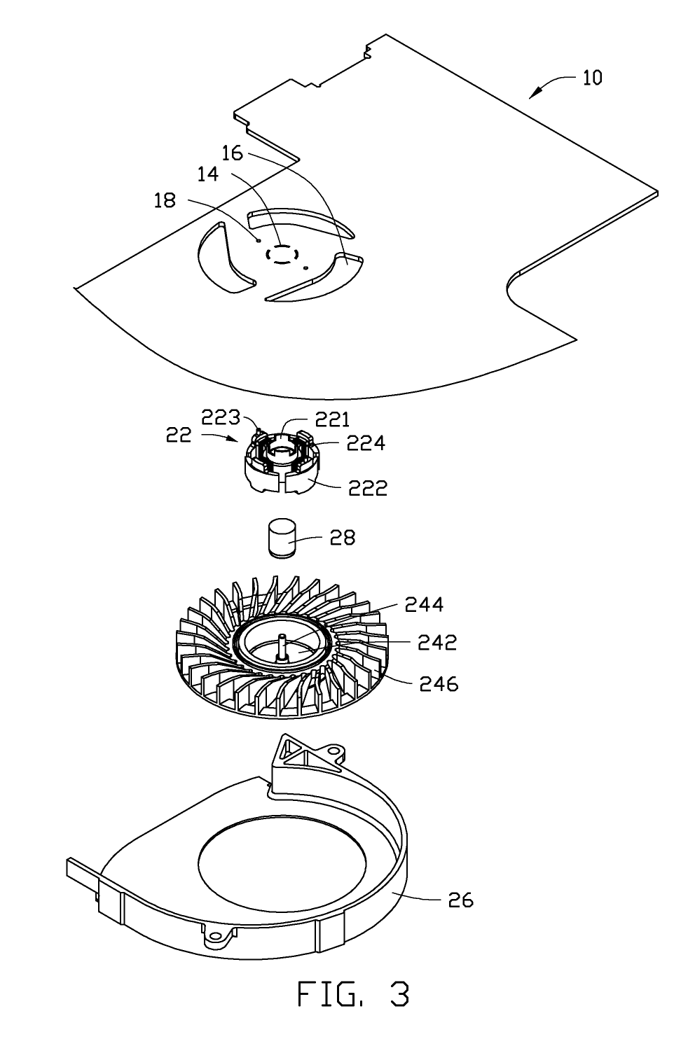

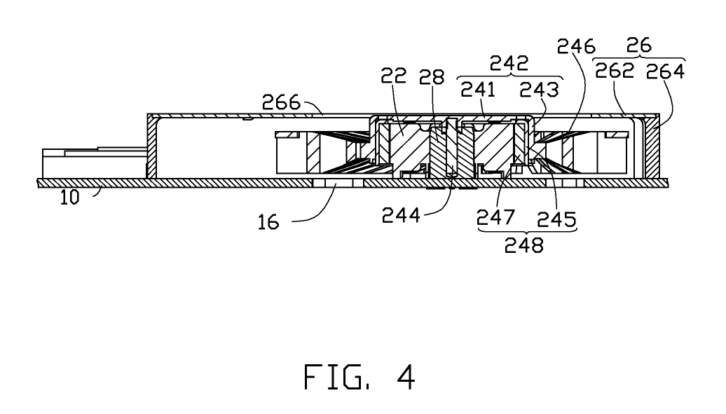

Also referring to FIGS. 2-4, the mainboard 10 defines a plurality of spaced arc-shaped inserting holes 14, two through holes 18 located at a periphery of the inserting holes 14, and a plurality of spaced first air inlets 16 located at a periphery of the through holes 18. The inserting holes 14 are located on a same circle.

The fan 20 includes a stator 22, a rotor 24, and a fan frame 26. The stator 22 includes a stator core 222, and a plurality of stator coils 224. The stator coils 224 are wound on the stator core 222. The stator core 222 defines a through hole 226 in a center thereof. A sleeve 28 is received in the through hole 226 of the stator core 222. A plurality of arc-shaped inserting portions 221 and two protrusions 223 are formed at a bottom of the stator core 222. The inserting portions 221 are located at the center of the stator core 222. The protrusions 223 are located at a periphery of the inserting portions 221 at intervals. The inserting portions 221 and the protrusions 223 are inserted into the inserting holes 14 and the through holes 18 of the mainboard 10 respectively to fix the stator 22 on the mainboard 10. The mainboard 10 is electrically connected with the stator coils 224 to provide electrical current to the stator coils 224.

The rotor 24 includes a hub 242, a shaft 244, a plurality of blades 246 and a magnet unit 248. The hub 242 covers around a periphery of the stator 22, and includes a circular top wall 241 and a cylindrical sidewall 243 extending downwardly from an outer periphery of the top wall 241. The blades 246 extend radially and outwardly from an outer surface of the sidewall 243 of the hub 242. The top wall 241 and the sidewall 243 cooperatively define a space in the hub 242 for receiving the magnet unit 248 and the stator 22 therein. An end of the shaft 244 is fixed at a central portion of the top wall 241 of the hub 242, another end of the shaft 244 is inserted into the sleeve 28. The magnet unit 248 includes a hollow shell 245 and a cylindrical permanent magnet 247 received in the shell 245. The shell 245 is attached to an inner surface of the sidewall 243 of the hub 242.

The fan frame 26 is fixed at the mainboard 10, and covers the stator 22 and the rotor 24. The fan frame 26 includes a cover plate 262 and a sidewall 264 extending perpendicularly downward from an outer edge of the cover plate 262. The cover plate 262 defines a second air inlet 266 corresponding to the first air inlets 16 of the mainboard 10. An air outlet 268 is defined in the sidewall 264. A fixing portion 263 protrudes horizontally outward from a periphery of the sidewall 264 for mounting the fan frame 26 on the mainboard 10. The cover plate 262, the sidewall 264 and the mainboard 10 cooperatively define a chamber (not labeled) receiving the stator 22 and the rotor 24 therein.

According to the disclosure, the stator 22 of the fan 20 is directly fixed on and directly electrically connected to the mainboard 10, electrical wires used for interconnecting the mainboard 10 with the fan 20 are thereby saved. Therefore, the mainboard 10 and the fan 20 would not occupy too much space.

It is believed that the embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic device comprising:
a mainboard; and
a fan mounted on the mainboard, the fan comprising a stator and a rotor, the rotor comprising a hub covering around a periphery of the stator and a plurality of blades disposed at a periphery of the hub, the stator being directly fixed to and directly electrically connected to the mainboard.

2. The electronic device of claim 1, wherein the mainboard defines a plurality of spaced arc-shaped inserting holes, a plurality of arc-shaped inserting portions being formed at a bottom of the stator, the inserting portions being inserted into the inserting holes of the mainboard to fix the stator on the mainboard.

3. The electronic device of claim 2, wherein the inserting holes are located on a same circle.

4. The electronic device of claim 2, wherein the mainboard defines two through holes located at a periphery of the inserting holes, two protrusions being formed at the bottom of the stator, the inserting portions being located at a center of the stator, the protrusions being located at a periphery of the inserting portions, the protrusions being inserted into the through holes of the mainboard to further fix the stator on the mainboard.

5. The electronic device of claim 4, wherein the mainboard defines a plurality of air inlets located at a periphery of the through holes.

6. The electronic device of claim 1, wherein the fan further comprises a fan frame fixed on the mainboard, the fan frame comprising a cover plate and a sidewall extending downward from an outer edge of the cover plate, the cover plate defining an air inlet, an air outlet being defined in the sidewall, the cover plate, the sidewall and the mainboard cooperatively defining a chamber receiving the stator and the rotor therein.

7. The electronic device of claim 6, wherein a fixing portion protrudes outward from a periphery of the sidewall for mounting the fan frame on the mainboard.

8. The electronic device of claim 6, wherein the mainboard defines another air inlet corresponding to the air inlet of the fan frame.

9. The electronic device of claim 1, wherein the stator comprises a stator core and a plurality of stator coils, the stator coils being wound on the stator core, the mainboard being electrically connected with the stator coils to provide electrical current to the stator coils.

10. The electronic device of claim 9, wherein the stator core defines a through hole in a center thereof, a sleeve being received in the through hole of the stator core.

11. The electronic device of claim 10, wherein the rotor further comprises a shaft, an end of the shaft being fixed at a center of the hub, another end of the shaft being inserted into the sleeve.

12. The electronic device of claim 11, wherein the hub comprises a top wall and a cylindrical sidewall extending downwardly from an outer periphery of the top wall, the blades extending radially and outwardly from an outer surface of the sidewall of the hub, the shaft being fixed at a central portion of the top wall of the hub.

13. The electronic device of claim 12, wherein the rotor further comprises a magnet unit, the magnet unit comprising a hollow shell and a cylindrical permanent magnet received in the shell, the shell being attached to an inner surface of the sidewall of the hub.

14. An electronic device comprising:
a mainboard; and
a fan comprising a fan frame, a stator and a rotor, the stator being fixed on and electrically connected to the mainboard, the fan frame comprising a cover plate and a sidewall extending downward from the cover plate, the sidewall being engaged on the mainboard, the cover plate, the sidewall and the mainboard cooperatively defining a chamber receiving the stator and the rotor therein.

15. The electronic device of claim 14, wherein the mainboard defines a plurality of spaced arc-shaped inserting holes, a plurality of arc-shaped inserting portions being formed at a bottom of the stator, the inserting portions being inserted into the inserting holes of the mainboard to fix the stator on the mainboard.

16. The electronic device of claim 15, wherein the inserting holes are located in a same circle.

17. The electronic device of claim 15, wherein the mainboard defines two through holes located at a periphery of the inserting holes, two protrusions being formed at the bottom of the stator, the inserting portions being located at a center of the stator, the protrusions being located at a periphery of the inserting portions, the protrusions being inserted into the through holes of the mainboard to further fix the stator on the mainboard.

18. The electronic device of claim 17, wherein the mainboard defines a plurality of air inlets located at a periphery of the through holes.
